(19) United States
(12) Patent Application Publication
(10) Pub. No.: US 2022/0287273 A1
(43) Pub. Date: Sep. 15, 2022

(54) PET TOY WITH RETRACTABLE CORD

(71) Applicant: Brad Woods Design, LLC, Wimberley, TX (US)

(72) Inventor: Bradley Woods, Wimberley, TX (US)

(73) Assignee: Brad Woods Design, LLC, Wimberley, TX (US)

(21) Appl. No.: 17/691,826

(22) Filed: Mar. 10, 2022

Related U.S. Application Data
(60) Provisional application No. 63/158,953, filed on Mar. 10, 2021.

(51) Int. Cl. A01K 15/02

(52) U.S. Cl. CPC A01K 15/025

(57) ABSTRACT

A pet toy that includes a retracting mechanism enclosed within a durable casing. The retracting mechanism is enclosed within a resilient casing which is surrounded by a main body. The retracting mechanism includes a spring-loaded spool with a retractable cord attached thereto. A grip is connected to an opposite end of the cord. When the toy is at rest the cord is wound bout the spool of the retractable mechanism and the grip comes to rest against the main body of the pet toy. In use, the grip can allow the swinging in a circular motion of the pet toy causing the retractable cord to extend. The inertia generated by the motion of the pet toy extends the cord out and away from the grip. Upon release, the cord retracts back into the casing as the pet toy is propelled through the air.

### CROSS REFERENCE TO RELATED APPLICATION

This application claims priority to U.S. Provisional Application No. 63/158,953 filed Mar. 10, 2021, which is hereby incorporated herein by reference in its entirety.

### TECHNICAL FIELD

The present disclosure relates generally to the field of pet toys, and more particularly, to a pet toy for throwing.

### DESCRIPTION OF RELATED ART

Pet toys have been developed to provide increased functionality for improved and extended interaction for animals. It is known in the art to use a stick or branch from a tree or other elongated apparatus as a toy for a dog. Dogs often enjoy playing fetch where a stick or other object like a ball is thrown for the dog to retrieve. Over the years the well-loved game of fetch has been improved to include the use of balls, frisbees, or other toys specifically designed for dogs.

Launchers have been developed for dog balls to help reduce shoulder and elbow stress from throwing and to help throw objects farther. Dog ball launchers can resemble a long stick with a handle on one end and a ball holder on the other end. To throw the ball with this type of launcher, the ball is added to the ball holder, then using the handle, the launcher is thrusted forward thereby releasing and launching the ball to a distance much farther than can be reached by a typical hand-throwing motion.

However, when using a launcher, it can be difficult for the use of both hands to play with the dog or to use both hands to pull the ball out of the dog's mouth without laying the launcher down. Also, launchers are typically bulky, so they can be difficult to carry and store. In addition, with only one ball launcher, it can be difficult for multiple users to play fetch with a dog at the same time. Launchers can typically be designed for specific balls, so each different size ball requires a different launcher and sometimes may not be available for a dog's favorite ball or toy. A need remains for improved throwing toys for pets.

### SUMMARY

The present disclosure provides for a throwing pet toy including: (a) a main body defining an object configured to stimulate attention from a pet, the main body defining a first opening; (b) a casing defining a second opening and enclosed within the main body, the casing formed a material resistant to destructive chewing and playing by the pet; and (c) a retractable mechanism having a retractable cord connected to a grip at a distal end and a spring-loaded spool at a proximal end. The grip is accessible from outside the main body. The retractable cord passes through the first opening of the main body and the second opening of the casing and is configured to extend out and away from the casing in response to a pulling force on the grip and retract back into the casing upon release. In an example, the material of the casing is rubber formulated to withstand destructive chewing and playing by the pet and configured to enclose the retractable mechanism to prevent access by the pet. The rubber can be selected from the group consisting of natural rubber, latex rubber, thermoplastic, and combinations thereof.

In an example, the casing is fixed within the main body and the first opening, and the second opening are aligned with respect to each other configured to allow for cord movement from a retracted to an extended configuration. The retractable cord extends in response to a pulling or centrifugal force applied to the main body while the grip is held and prior to release. The main body should be configured to launch and fly an extended distance away from a release point upon release of the grip when the main body is in a partial or fully extended configuration in response to the centrifugal force. In another example, the grip includes a tab configured to prevent the grip from retracting into the main body or the casing.

The pet toy can further include a noise maker configured to emit a sound in response to biting, movement, or play by the pet. The sound can be a squeaking sound. The pet toy can be configured to be a dog toy for use with a dog. The object of the main body can define a ball shape. In a further example, the object defines an animal form selected from the group consisting of a duck, a dog, a cat, a mouse, a sheep, a chicken, and combinations thereof.

In yet another example, the casing is removable from the main body and configured to securely be enclosed into a different main body. The main body defines a gripping cavity sized to receive the grip in a retracted configuration and allow access to the grip within the cavity. The grip in the retracted configuration rests in the gripping cavity and does not extend beyond an outer perimeter of the main body. The gripping cavity is sized and shaped to restrict biting access by the pet. Th pet toy can further include internal stuffing material positioned within the main body and surrounding the casing. Each of the first opening and the second opening can be sized to allow the threading of the retractable cord therethrough and prevent the grip and external foreign objects from entering the main body or the casing. The retractable mechanism can be configured to wind the retractable cord around the spring-loaded spool in a retracted state. The object of the main body can be formed of pet-friendly fabric material.

### BRIEF DESCRIPTION OF THE DRAWINGS

The figures which accompany the written portion of this specification illustrate embodiments and method(s) of use for the present disclosure constructed and operative according to the teachings of the present disclosure.

FIG. 1A illustrates a side view of a pet toy ball object according to the present disclosure.

FIG. 1B illustrates a cross-section view of the pet toy of FIG. 1A.

FIG. 1C illustrates a schematic of the pet toy of FIG. 1A in use with a retracting cord in an extended position prior to launching of the toy.

FIG. 2A illustrates a side view of another example a pet toy as a ball object according to the present disclosure.

FIG. 2B illustrates a cross-section view of the pet toy of FIG. 2A.

FIG. 2C is a schematic view of the pet toy of FIG. 2A showing a user grasping a grip within a cavity.

FIG. 3A illustrates a side view of a further example of a pet toy as an animal object according to the present disclosure.

FIG. 3B is a cross section view of the pet toy of FIG. 3A.

FIG. 3C illustrates a further example of a pet toy as an animal object having a grasping cavity.

FIG. 3D illustrates a cross-section view of the pet toy of FIG. 3C.

FIG. 4 is a cross section view of a pet toy of the present disclosure showing internal features of the main body as a ball object with a retracting cord partially extending and a rounded grip feature.

FIG. 5 is a cross section view of a pet toy of the present disclosure showing internal casing structure.

FIG. 6 is a schematic view of a casing with a retractable mechanism and modular main bodies.

### DETAILED DESCRIPTION

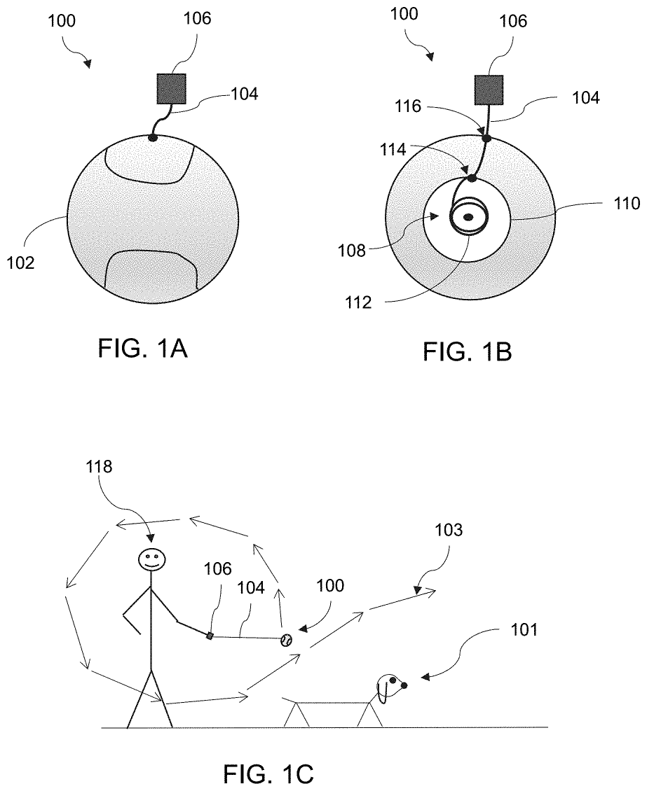

Referring to FIGS. 1A-1C, the present disclosure provides for a pet toy 100 having a main body 102 defining an object in a shape of a ball. The main body 102 can be made from a flexible, resilient material for example fabric, vinyl, a natural or synthetic rubber or rubber like material, or the like, including any combination thereof. The material should be selected to be safe for a pet to chew or engage with. Pet toy 100 includes a retractable cord 104 which can extend from a retracted state at rest (FIG. 1A) to a fully extended state (FIG. 1C). The retractable cord 104 can be made of any flexible and durable material including but not limited to a rope, string, wire, cord, chain, or the like. Cord 104 passes through a first opening 116 defined on an outer surface of 102 sized to allow cord 104 to move freely from the retracted to the extended state.

Pet toy 100 further includes a grip 106 attached to the retractable cord 104 at a distal end that is accessible without physically grabbing the main body 102 itself. This allows a user 118, like a pet owner or guardian, to grab the grip 106 for use and play of toy 100. In an example, grip 106 can define any suitable shape like a knob, tab, or the like. In another example the grip 106 can be a handle or a handle-like structure. The grip may be constructed of any soft or rigid structure, for example, cloth, leather, vinyl, nylon, acrylonitrile-butadiene-styrene (ABS), plastic, metal, a bisphenol A (BPA) -free material, a non-toxic material, a phthalate-free material, a latex-free material, or any combination of the above.

Pet toy 100 includes a retracting mechanism 108 located within a casing 110. The casing 110 is made of a material resistant to the biting, chewing, and general playing of a pet, such as a dog 101. The casing 110 should be safe yet resilient and may be comprised of a solid pliable foam material, natural or synthetic rubber, plastic, acrylonitrile butadiene styrene (ABS), thermoplastic elastomer (TPE), thermoplastic rubber (TPR), or any combination thereof. The retracting mechanism 108 can include a spring-loaded spool 112 which permits the retractable cord 104 to be wound about the spool 112. The spool 112 may be a conventional recoil or retract mechanism in which the retracting mechanism 108 allows the cord 104 to be pulled out and away from the center of the pet toy 100 and then automatically wound about the spool 112 when the grip 106 is released. Accordingly, when the pet toy 100 is at rest, the cord is retracted and wound around spool 112.

Retracting mechanism 108 is positioned within the casing 110. Casing 110 defines a second opening 114 sized and shaped to allow cord 104 to pass therethrough. In an example, first opening 114 and second opening 116 are aligned to further facilitate movement of cord 104 in and out of the casing 110 and main body 102 during use. In an example, the second opening 114 or first opening 116 may be supported by a flange, grommet, or any other supporting structure. Retractable cord 104 is attached to the spool 112 at a proximal end of cord 104 and the remainder of the cord 104 is wound about the spool 112 in a retracted state. Cord 104 extends through second opening 116 of the casing 110 and first opening 114 of the main body 102 to a distal end at grip 106. The grip 106 is configured to be larger than the first opening 116 such that when the cord 104 is fully retracted the grip 106 prevents the cord from fully being enclosed within the main body 102 or casing 110.

During use, a schematic of a user 118 is shown playing with a pet 101. In this example, pet 101 is a dog 101. User 118 is shown holding grip 106 and swinging the pet toy 100 in a circular motion defined by motion path 103. As the pet toy 100 is swung, a centrifugal force from the inertia of the pet toy 100 causes the cord 104 to extend out and away from grip 106. As the pet toy 100 swings around along motion path 103, the pet toy 103 can be released. By releasing the grip 106, pet toy 100 is thrown/launched in a direction of motion as schematically shown by path 103. Once the grip 106 is released the cord 104 retracts or recoils back into casing 112

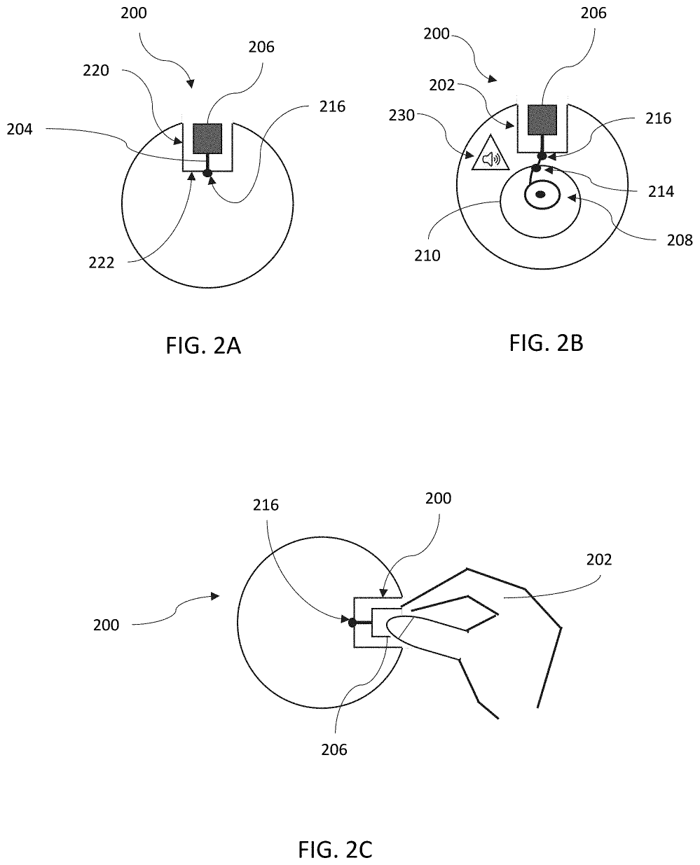

Referring to FIGS. 2A-2C, an example pet toy 200 is shown having a main body 202 defining an object as a ball, similar to the example shown in FIGS. 1A-1C. In this example, main body 202 defines a gripping cavity 220 sized to receive and a position a grip 206 therein. The gripping cavity 220 is configured to allow gripping access by a user to the grip 206. Gripping access can be defined as allowing two fingers or more of a user's hand 202 to access grip 206 for pulling or play. Grip 206 is connected to a retractable cord 204 at a distal end. In a fully retracted state, the grip 206 does not extend beyond an outer perimeter defined by main body 202. The gripping cavity 220 allows for grasping grip 206 by inserting one or more fingers or the like into cavity 220. Cavity 220 is also sized and shaped to restrict or even prevent access by a pet, like a dog 101 (See FIG. 1C). The receiving cavity 220 helps reduce and/or prevent destruction of the grip 206 during play other behavior like chewing or biting. A floor 222 is formed within cavity 220 as a physical barrier to grip 206. Floor 222 forms a portion of the outer surface of main body 202 intended from an outer perimeter of main body 202.

In an example, gripping cavity 220 is formed deep enough in relation to the outer surface of main body 202 to receive the grip 206 without the grip 206 extending beyond an outer perimeter of main body 202. Grip 206 rests against or adjacent to floor 222. In this example a first opening 216 is defined on floor 222 and operates similarly to the first opening 116 of FIGS. 1A-1C, wherein the first opening 216 is sized to allow passage of the retractable cord 204 to move freely between a retracted and extended state, when a pulling force is applied, but still prevents grip 206 from entering an interior body of main body 210, resulting in grip 206 resting in the gripping cavity 220.

Pet toy 200, like pet toy 100 of FIG. 1A-1C, includes an interior casing 210 enclosing a retracting mechanism 208. In a further example, first opening 216 formed on floor 222 of cavity 220 and second opening 214 of casing 210 align to facilitate movement of retractable cord 204 from a retracted to an extended state. Retracting mechanism 208 is enclosed within the casing 210 and includes a spring-loaded spool 212 connected to retractable cord 204. Casing 210 defines a second opening 214 sized and shaped to allow cord 204 to pass therethrough. Retractable cord 204 is attached to a spool 212 at a proximal end of cord 204 and the remainder of the cord 204 is wound about the spool 212 in a retracted state. Cord 204 extends through second opening 214 of casing 210 and first opening 216 of the main body 202 to a distal end at grip 206. The grip 206 is configured to be larger than the first opening 216 such that when the cord 204 is in a retracted state, the grip 206 prevents the cord from fully being enclosed within the main body 202 or casing 210.

In a further example, pet toy 200 further includes a noise maker device 230 configured to generate a noise in response to movement caused by play, chewing, biting, etc. The noise emitted by noise maker 230 can be a squeaky sound configured to stimulate and/or attract the attention of a pet or dog.

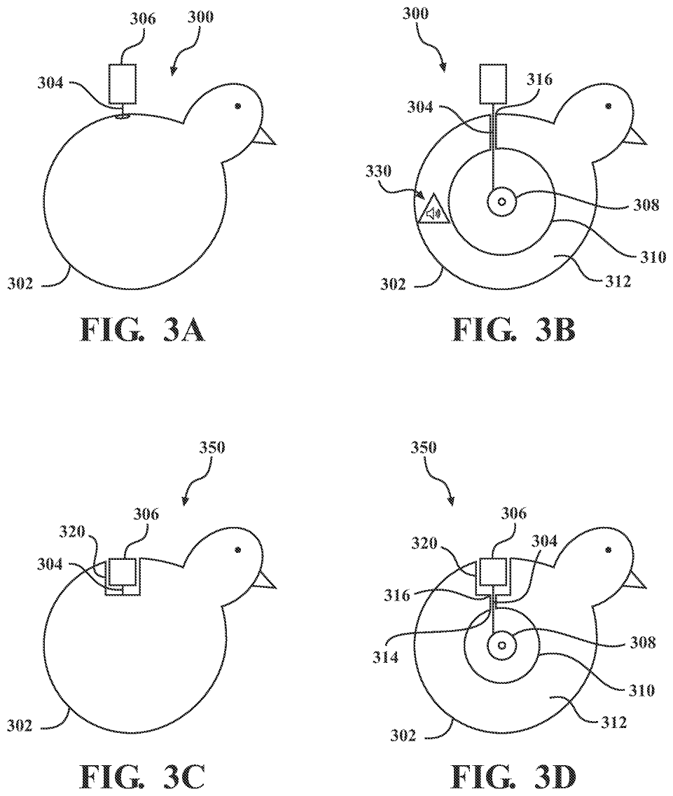

Referring to FIGS. 3A-3D, the present disclosure provides for other example shapes and designs of pet toy 300 and 350. In this example, pet toy 300 and 350 define an object as an animal shape rather than a ball like a duck, chicken, etc. The object form of pet toy 300 and 350 can be any decorative and/or desirable shape that helps attract the attention of a pet. Main body 302 may be shaped like a duck, a dog, a cat, a mouse, a sheep, a chicken, or any other animal. In an example main body 302 may be filled with a stuffing material 312 surrounding a casing 210. The stuffing material 312 may be synthetic, natural or a combination of both. The material should be selected to be safe for a pet to chew or play with. The stuffing material 312 may comprise polyester, cotton, wool, mohair, bamboo fiber, corn fibers, or polylactic acid (PLA) fibers or a combination thereof. The stuffing 312 may be non-toxic, phthalate-free, latex free, or BPA-free.

FIGS. 3A-3B illustrate a pet toy 300 having a duck form for main body 302 with an otherwise similar construction of the examples of FIGS. 1A-1C, having a grip 306 connected to a retractable cord 304 connected to a retracting mechanism 308 enclosed by a casing 310. A first opening 316 is formed on main body 302 and a second opening is defined on casing 310 with both openings sized and shaped to allow for retractable cord 304 to pass therethrough.

FIGS. 3C-3D illustrate a pet toy 350, similar to the pet toy 300, having a duck form for main body 302 with an otherwise similar construction of the examples of FIGS. 2A-2C. Pet toy 350 includes a grip 306 connected to a retractable cord 304 connected to a retracting mechanism 308 enclosed by a casing 310. Pet toy 350 further includes a gripping cavity 320 defined along a perimeter of main body 302 sized and shaped to receive grip 306 to allow user access while preventing or reducing access by a pet through playing, chewing, or biting. A first opening 316 is formed within gripping cavity 320 and a second opening 314 is defined on casing 310 with both openings sized and shaped to allow for retractable cord 304 to pass therethrough.

In a further example, pet toy 300 further includes a noise maker device 330 configured to generate a noise in response to movement caused by play, chewing, biting, etc. The noise emitted by noise maker 330 can be a squeaky sound configured to stimulate and/or attract the attention of a pet or dog.

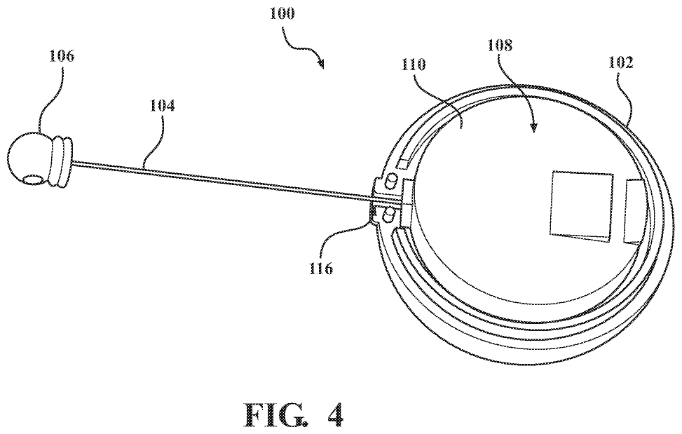

Referring to FIG. 4, the present disclosure provides for a cross sectional view of an example pet toy 100. Retractable mechanism 108 is positioned within casing 110. The casing 110 may be formed such that it provides a support structure to house the retracting mechanism 108 and securely fits within an interior wall formed of main body 102. The casing 110 and main body 102 can define a ball object, common for playing fetch or other game for a pet.

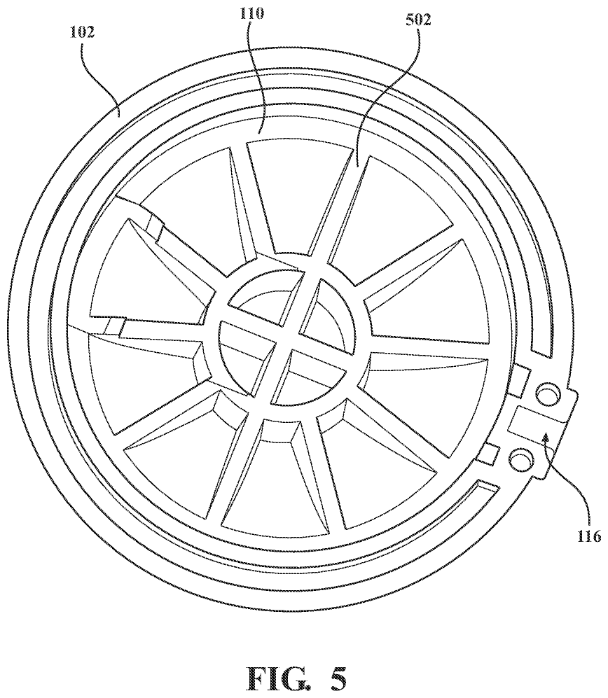

FIG. 5 illustrates a further cross section view showing interior surfaces of casing 110 and main body 102. In this example, casing 110 includes structural radial ribs 502 that may provide additional support to prevent or reduce destruction during use. The radial ribs 502 may further be formed to hold a retractable mechanism in a desired position. The radial ribs 502 may also be formed to provide resilient protection against throwing, tossing, impact, or the chewing and playing action of a pet. In a further example, the ribs 502 may be formed to receive a noise maker 230/330 that provides a noise, such as squeaking, while a pet is chewing or playing with the pet toy. The noise maker may be a traditional squeaker that is characterized by a small tubular section of material with a flexible reed disposed within the tube. A pet may bite down on the pet toy and casing which may force air through the noise maker which may result in the production of a sound.

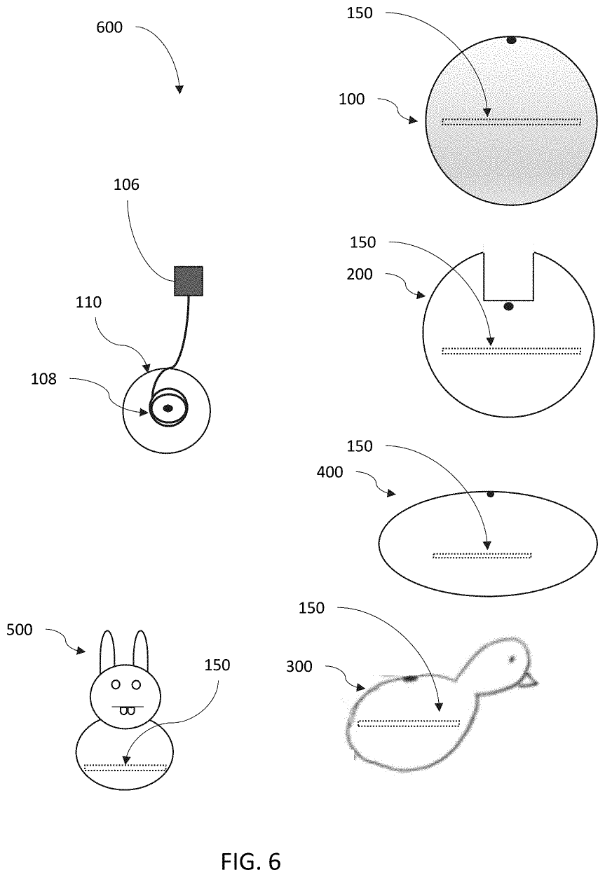

Referring to FIG. 6, in a further example, a modular system 600 is provided that includes a casing 110 enclosing a retracting mechanism 108 having a retractable cord 104 extending to a grip 106. Casing 110 is configured to fit within one or more removable and replaceable main bodies of pet toys 100, 200, 300, 400, and 500. The main bodies can be similar (like ball 100 and ball 200 defining gripping cavity). The main bodies can be made to be disposable after normal wear and tear or alternatively, define different shapes and objects to allow for variation in play. The main bodies can further be formed of fabric or other suitable material configured for play by a pet like a dog and throwing/flying through the air. For example, one main body can be a ball/sphere shape pet toy 100/200, while another main body can define an oblong football shape of football pet toy 400 or a bone shape (not shown). In yet another example, the shape can be an animal form like a duck 300 or a rabbit/bunny 500. In yet another example, for a modular system, the main body can include a zipper feature 150 or other opening to allow for access and inserting the casing 110 therein prior to use.

Based upon the foregoing description, it is apparent that the pet toy and method of operation allows for an improved experience while playing with a pet. The recessed grip allows for a cleaner and more sanitary grasp of the pet toy by discouraging a pet from chewing on the grip and thus preventing saliva from accumulating on the grip. As described, the grip is also attached to a retractable cord that allows for a guardian to use inertia to throw the pet toy farther and with less effort.

While particular embodiments and applications of the present invention have been illustrated and described it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A throwing pet toy comprising:
(a) a main body defining an object configured to stimulate attention from a pet, the main body defining a first opening;
(b) a casing defining a second opening and enclosed within the main body, the casing formed a material resistant to destructive chewing and playing by the pet; and
(c) a retractable mechanism having a retractable cord connected to a grip at a distal end and a spring-loaded spool at a proximal end;
wherein the grip is accessible from outside the main body, and wherein the retractable cord passes through the first opening of the main body and the second opening of the casing and is configured to extend out and away from the casing in response to a pulling force on the grip and retract back into the casing upon release.

2. The throwing pet toy of claim 1, wherein the material of the casing is rubber formulated to withstand destructive chewing and playing by the pet and configured to enclose the retractable mechanism to prevent access by the pet.

3. The throwing pet toy of claim 2, wherein the rubber is selected from the group consisting of natural rubber, latex rubber, thermoplastic, and combinations thereof.

4. The throwing pet toy of claim 1, wherein the casing is fixed within the main body and the first opening and the second opening are aligned with respect to each other configured to allow for cord movement from a retracted to an extended configuration.

5. The throwing pet toy of claim 1, wherein the retractable cord extends in response to a centrifugal force applied to the main body while the grip is held and prior to release.

6. The throwing pet toy of claim 5, wherein the main body is configured to launch and fly an extended distance away from a release point upon release of the grip when the main body is in a partial or fully extended configuration in response to the centrifugal force.

7. The throwing pet toy of claim 1, wherein the grip includes a tab configured to prevent the grip from retracting into the main body or the casing.

8. The throwing pet toy of claim 1, further comprising a noise maker configured to emit a sound in response to biting, movement, or play by the pet.

9. The throwing pet toy of claim 8, wherein the sound is a squeaking sound.

10. The throwing pet toy of claim 1, wherein the pet is a dog.

11. The throwing pet toy of claim 1, wherein the object defines a ball shape.

12. The throwing pet toy of claim 1, wherein the object defines an animal form selected from the group consisting of a duck, a dog, a cat, a mouse, a sheep, a chicken, and combinations thereof.

13. The throwing pet toy of claim 1, wherein the casing is removable from the main body and configured to securely be enclosed into a different main body.

14. The throwing pet toy of claim 1, wherein the main body defines a gripping cavity sized to receive the grip in a retracted configuration and allow access to the grip within the cavity, wherein the grip in the retracted configuration does not extend beyond an outer surface of the main body.

15. The throwing pet toy of claim 14, wherein the gripping cavity is sized and shaped to restrict biting access by the pet.

16. The throwing pet toy of claim 1, further comprising an internal stuffing material positioned within the main body and surrounding the casing.

17. The throwing pet toy of claim 1, wherein each of the first opening and the second opening are sized to allow the threading of the retractable cord therethrough and prevent the grip and external foreign objects from entering the main body or the casing.

18. The throwing pet toy of claim 1, wherein retractable mechanism is configured to wind the retractable cord around the spring-loaded spool in a retracted state.

19. The throwing pet toy of claim 1, wherein the object of the main body is formed of pet-friendly fabric material.
